(19) United States
(12) Patent Application Publication
(10) Pub. No.: US 2017/0047022 A1
(43) Pub. Date: Feb. 16, 2017

(54) DISPLAY APPARATUS AND CONTROL METHOD THEREOF

(71) Applicant: CANON KABUSHIKI KAISHA, Tokyo (JP)

(72) Inventor: Takeshi Ikeda, Ebina-shi (JP)

(21) Appl. No.: 15/334,694

(22) Filed: Oct. 26, 2016

Related U.S. Application Data
(63) Continuation of application No. PCT/JP2015/062897, filed on Apr. 28, 2015.

(30) Foreign Application Priority Data
Apr. 28, 2014 (JP) 2014-092850

(51) Int. Cl. G09G 3/34; G09G 3/36

(52) U.S. Cl. CPC G09G 3/3413; G09G 3/36; G09G 2320/0646; G09G 2330/021; G09G 2320/066

(57) ABSTRACT

A display apparatus includes a light emitting unit having a plurality of blocks of which brightness can be controlled independently; a display unit configured to display an image by modulating light from the light emitting unit; an input unit configured to input information on a specified region, specified by a user, in the image; and a control unit configured to control brightness of the plurality of blocks, wherein in a case where the information on the specified region is input, the control unit controls brightness of a block corresponding to a sub-region that includes the specified region, among a plurality of sub-regions of the image corresponding to the plurality of blocks, to a brightness higher than that in a case where the information on the specified region is not input.

### CROSS-REFERENCE TO RELATED APPLICATIONS

This application is a Continuation of International Patent Application No. PCT/JP2015/062897, filed Apr. 28, 2015, which claims the benefit of Japanese Patent Application No. 2014-092850, filed Apr. 28, 2014, both of which are hereby incorporated by reference herein in their entirety.

### BACKGROUND OF THE INVENTION

Field of the Invention

The present invention relates to a display apparatus and a control method thereof.

Background Art

In a display apparatus that uses a liquid crystal device, a technique of dividing the screen into a plurality of backlight blocks and controlling the brightness of the backlight and transmittance of liquid crystals based on the image data is used (e.g. see PTL 1, hereafter this technique is called “local dimming”). By local dimming, black floaters in a dark area of the image can be reduced, and contrast can be improved. Further, for a display apparatus that displays an image captured by X-rays or the like, a technique to distinguish between a dark background region and a diagnostic region which includes an object, and to decrease the brightness of the backlight in the background region, has been proposed (PTL 2).

For the display of medical images, on the other hand, a display apparatus that can implement higher brightness is demanded. This is because the range of the JND (Just Noticeable Difference) values specified by a DICOM (Digital Imaging and Communication in Medicine) standard, which is a standard of medical imaging apparatuses, can be set wider. The JND value indicates a minimum brightness difference which an average observer can notice under certain conditions, and is specified to a 0.05 cd/m² to 4000 cd/m² range by the DICOM standard. The standard specifies the correspondence of the JND value (integer) and the brightness (see FIG. 3B). As shown in FIG. 3B, if the contrast ratio of the display is constant, the possible range of the JND value increases as the brightness is higher. This means that the gradation resolution upon performing medical image diagnosis is higher, and diagnostic accuracy improves if a brighter monitor is used by increasing the brightness of the backlight.

However, if the brightness of the backlight is always high, the black in the background portion, other than the object image portion, included in the captured image, becomes bright, and black floaters are conspicuous, which interferes with visibility. Even if a background region other than the diagnostic region is darkened by the local dimming processing, the brightness difference between a bright region and a dark region increases, and a halo phenomenon, which is generated by the leakage of the bright light of the right backlight into a dark region, also become conspicuous. Moreover, if the brightness of the backlight is always high, power consumption increases.

With the foregoing in view, it is an object of the present invention to provide a display apparatus that displays a medical image, by which a medical image can be observed at high diagnostic accuracy, while suppressing the interference of black floaters and the halo phenomenon, and reducing power consumption.

### CITATION LIST

### Patent Literature

PTL1 Japanese Patent Application Laid-open No. 2002-99250

PTL2 Japanese Patent Application Laid-open No. 2013-148870

### SUMMARY OF THE INVENTION

The present invention is a display apparatus, comprising:

a light emitting unit having a plurality of blocks of which brightness can be controlled independently;

a display unit configured to display an image by modulating light from the light emitting unit;

an input unit configured to input information on a specified region, specified by a user, in the image; and

a control unit configured to control brightness of the plurality of blocks, wherein

in a case where the information on the specified region is input, the control unit controls brightness of a block corresponding to a sub-region that includes the specified region, among a plurality of sub-regions of the image corresponding to the plurality of blocks, to a brightness higher than that in a case where the information on the specified region is not input.

The present invention is an output apparatus, comprising:

a connection unit for connecting to a display apparatus that includes a light emitting unit having a plurality of blocks of which brightness can be controlled independently, and a display unit configured to display an image by modulating light from the light emitting unit;

an acquisition unit configured to acquire information on the plurality of blocks in a case where the output apparatus is connected with the display apparatus;

an input unit configured to input information on a specified region, specified by a user, in the image; and

an output unit configured to output information for controlling brightness of at least one of the plurality of blocks, based on the information on the specified region and the information on the plurality of blocks, wherein

in a case where the information on the specified region is input, the output unit outputs, to the display apparatus, information for controlling brightness of a block corresponding to a sub-region that includes the specified region, among a plurality of sub-regions of the image corresponding to the plurality of blocks, to a brightness higher than that in a case where the information on the specified region is not input, based on the information on the plurality of blocks.

The present invention is a display system, comprising:

a display apparatus that includes a light emitting unit having a plurality of blocks of which brightness can be controlled independently, and a display unit configured to display an image by modulating light from the light emitting unit; and

an output apparatus configured to output an image to the display apparatus, wherein

the output apparatus includes:

an acquisition unit configured to acquire information on the light emitting unit from the display apparatus;

an operation unit configured to specify a specified region in the image by user operation; and

an output unit configured to output information on the specified region and the image to the display apparatus,

the display apparatus includes:

an input unit configured to input the information on the specified region and the image from the output apparatus; and

a control unit configured to control the brightness of the plurality of blocks, and

in a case where the information on the specified region is input, the control unit controls brightness of a block corresponding to a sub-region that includes the specified region, among a plurality of sub-regions of the image corresponding to the plurality of blocks, to a brightness higher than that in a case where the information on the specified region is not input.

The present invention is a control method for a display apparatus that includes a light emitting unit having a plurality of blocks of which brightness can be controlled independently, and a display unit configured to display an image by modulating light from the light emitting unit, the control method comprising:

inputting information on a specified region, specified by a user, in the image; and

controlling brightness of the plurality of blocks, wherein

in the controlling step, in a case where the information on the specified region is input in the inputting step, brightness of a block corresponding to a sub-region that includes the specified region, among a plurality of sub-regions of the image corresponding to the plurality of blocks, is set to a brightness higher than that in a case where the information on the specified region is not input.

The present invention is a non-transitory computer-readable storage medium that holds a program to cause a computer to execute each step of a control method for a display apparatus that includes: a light emitting unit having a plurality of blocks of which brightness can be controlled independently; and a display unit configured to display an image by modulating light from the light emitting unit,

the control method comprising:

inputting information on a specified region, specified by a user, in the image; and

controlling brightness of the plurality of blocks, wherein

in the controlling step, in a case where the information on the specified region is input in the inputting step, brightness of a block corresponding to a sub-region that includes the specified region, among a plurality of sub-regions of the image corresponding to the plurality of blocks, is set to a brightness higher than that in a case where the information on the specified region is not input.

Further features of the present invention will become apparent from the following description of exemplary embodiments with reference to the attached drawings.

### BRIEF DESCRIPTION OF THE DRAWINGS

FIG. 1 is a block diagram of a display system according to Example 1.

FIGS. 2A to 2C are examples of an input image, characteristic values and region determination according to Example 1.

FIGS. 3A to 3C show examples of a relationship of a JND value and brightness, and data for correction.

FIG. 4 shows an image of instructing a region of interest according to Example 1.

FIGS. 5A to 5C are example of a backlight lighting image and control values according to Example 1.

FIG. 6 is a functional block diagram of a viewer according to Example 1.

FIG. 7 is a functional block diagram of a viewer according to Example 2.

FIG. 8 shows an image of an enlarged display of a region of interest according to Example 2.

FIG. 9 is a block diagram of a display system according to Example 3.

FIG. 10 is a functional block diagram of a viewer according to Example 3.

FIG. 11 shows display images of a display apparatus according to Example 3.

FIGS. 12A to 12C show examples of characteristic values according to Example 3.

### DESCRIPTION OF THE EMBODIMENTS

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

### Industrial Applicability

### Example 1

In Example 1, a user (e.g. physician) specifies a region to be focused on for diagnosis (region of interest) in a viewer application installed on a workstation or the like. The display apparatus acquires information on the region of interest specified by the user (specified region) from the viewer application, and sets the brightness of the backlight at a position corresponding to the region of interest to be higher than the peripheral regions. This widens the range of possible JND values in the region of interest, hence display can be performed at high gradation resolution, and a highly accurate diagnosis can be performed. Further, the brightness is increased only in the backlight of the specified region of interest, therefore interference by black floaters and halos can be suppressed and power consumption can be reduced.

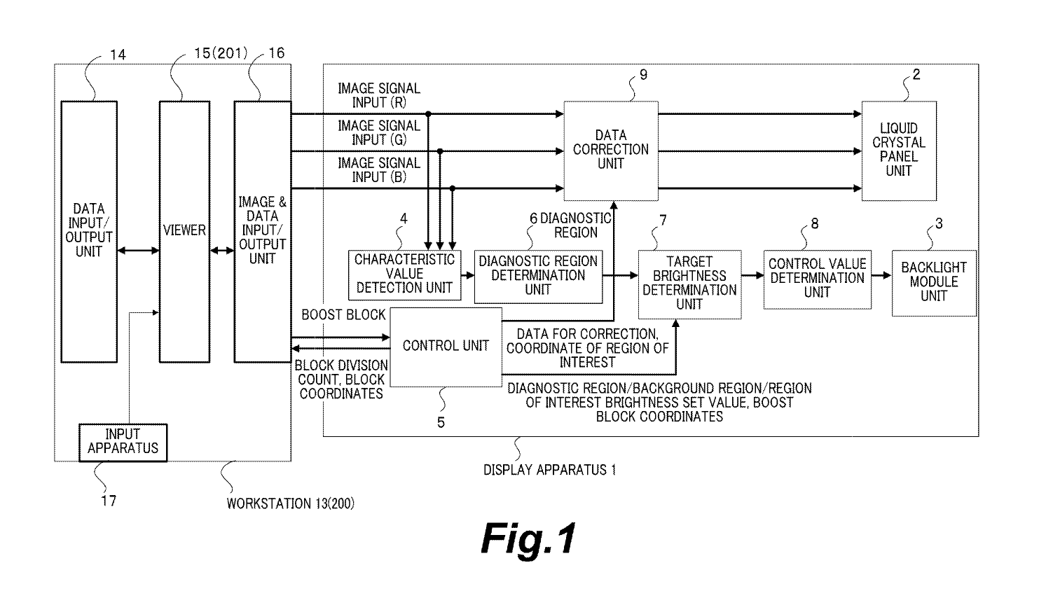

FIG. 1 is a functional block diagram of a display system according to Example 1. The display system in FIG. 1 is constituted by a display apparatus 1 and a workstation 13. The display apparatus 1 has a liquid crystal panel unit 2, a backlight module unit 3, a characteristic value detection unit 4, a control unit 5, a diagnostic region determination unit 6, a target brightness determination unit 7, a control value determination unit 8, and a data correction unit 9. The workstation 13 has a data input/output unit 14, a viewer 15, an image and data input/output unit 16, and an input apparatus 17. In FIG. 1, a reference number in parenthesis is a reference number used for Example 2 (workstation 200, viewer 201). The functions of the display apparatus 1 and the workstation 13 will now be described.

The liquid crystal panel unit 2 of the display apparatus 1 is constituted by a liquid crystal driver, a control board for controlling the liquid crystal driver using received input image data, and a liquid crystal panel that displays an image by modulating light from the backlight by transmitting at a transmittance based on the image data. The present invention is not limited to a display apparatus having a liquid crystal panel. The present invention can be applied to any display apparatus that uses a backlight, and can be applied, for example, to a display apparatus having a MEMS (Micro Electro Mechanical Systems) shutter type display panel.

The backlight module unit 3 is constituted by a light source, a control circuit configured to control the light source, and an optical unit used for diffusing light from the light source. The backlight is constituted by a plurality of blocks (light-emitting blocks) of which brightness of light emission can be controlled independently, and each block is constituted by one or a plurality of light source(s). The number of blocks is: m horizontal×n vertical (m and n are integers). The backlight of Example 1 is constituted by 70 blocks (10 blocks horizontal×7 blocks vertical). The light source of each block of a backlight is driven so as to turn ON at a brightness in accordance with a backlight control value determined by the control value determination unit 8. The light source is an LED (Light Emitting Diode), for example, but is not limited to an LED if the brightness of the light source is controllable.

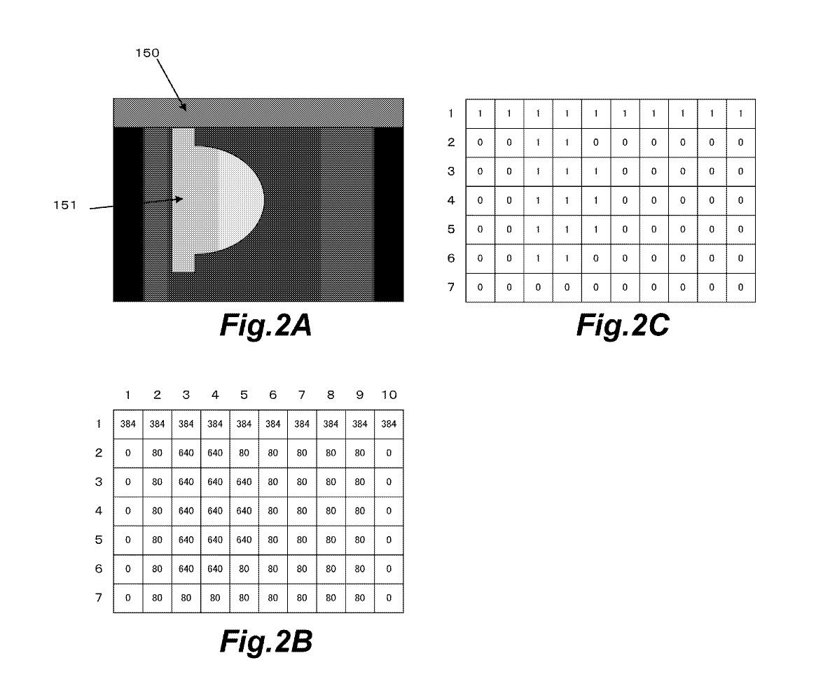

The characteristic value detection unit 4 divides an input image into regions corresponding to each block of the backlight, and detects the characteristic value of each sub-region. The characteristic value detection unit 4 sends the detected characteristic value to the diagnostic region determination unit 6 in a subsequent step. In Example 1, the characteristic value detection unit 4 detects the maximum values of the RGB values of each sub-region. The case when the input image data is as shown in FIG. 2 will be described. FIG. 2A shows an example of the input image, and FIG. 2B shows the maximum value of the RGB values of each sub-region, which is detected by the characteristic value detection unit 4 when the image in FIG. 2A is input. The numeric values 1 to 10 in the horizontal direction and 1 to 7 in the vertical direction in FIG. 2B indicate the coordinates of each sub-region in the horizontal direction and the vertical direction. The R, G or B values of the image data has 10 bits. The gradation of the image data is 0 to 1023. In FIG. 2A, an object 150 in the upper part of the screen is an image constituting a GUI (Graphic User Interface), which is output by a viewer application. The GUI includes a menu image, for example. The object 151 is an image of a diagnostic target object (image capturing target) (hereafter object image) in the image captured by X-rays or the like.

As shown in FIG. 2B, the characteristic value of a sub-region where the object image is disposed, out of the captured image, is 640, and the characteristic value of a sub-region, corresponding to a portion of the menu image constituting the viewer application screen, is 384. In the captured image, the characteristic value of a sub-region, corresponding to a background portion other than the object 151, is 80. In the viewer application screen, the characteristic value of a sub-region, corresponding to the background portion of a window where the captured image is disposed (background portion of GUI), is 0. The characteristic value detection unit 4 sends the detected characteristic value of each sub-region to the diagnostic region determination unit 6. In Example 1, the characteristic value detection unit 4 detects the maximum value of the RGB values in each sub-region as the characteristic value, but the characteristic value to be detected is not limited to this. For example, the characteristic value may be the number of pixels which are brighter than a certain standard, or an average value of the brightness of pixels in the sub-region. The input image may be a color image or a monochrome image (grayscale image).

The control unit 5 sends a block division count of the backlight and coordinates of each block to the workstation 13. The control unit 5 acquires the coordinates of a region of interest specified by the user from the workstation 13. The control unit 5 sends the acquired coordinates of the region of interest and brightness (boost brightness) of a block of the backlight corresponding to the region of interest (hereafter boost block) to the target brightness determination unit 7. The control unit 5 sends the brightness of the backlight of blocks corresponding to the diagnostic region and the background region to the target brightness determination unit 7. The diagnostic region, the background region and the region of interest are regions of the input image, and the target brightness determination unit 7 determines whether the region is a diagnostic region or background region based on the characteristic values of the image, as mentioned later. The region of interest is a region specified by the user.

The control unit 5 holds information on brightness that is applied to each block of the backlight corresponding to the diagnostic region, the background region and the region of interest. The brightness that is applied to each block of the backlight corresponding to the diagnostic region, the background region and the target region, may be a predetermined value or may be specified by the user using a viewer application running on a workstation. The control unit 5 sends the data for correction and coordinates of the region of interest to the data correction unit 9. The data for correction, which the control unit 5 creates, will be described in detail.

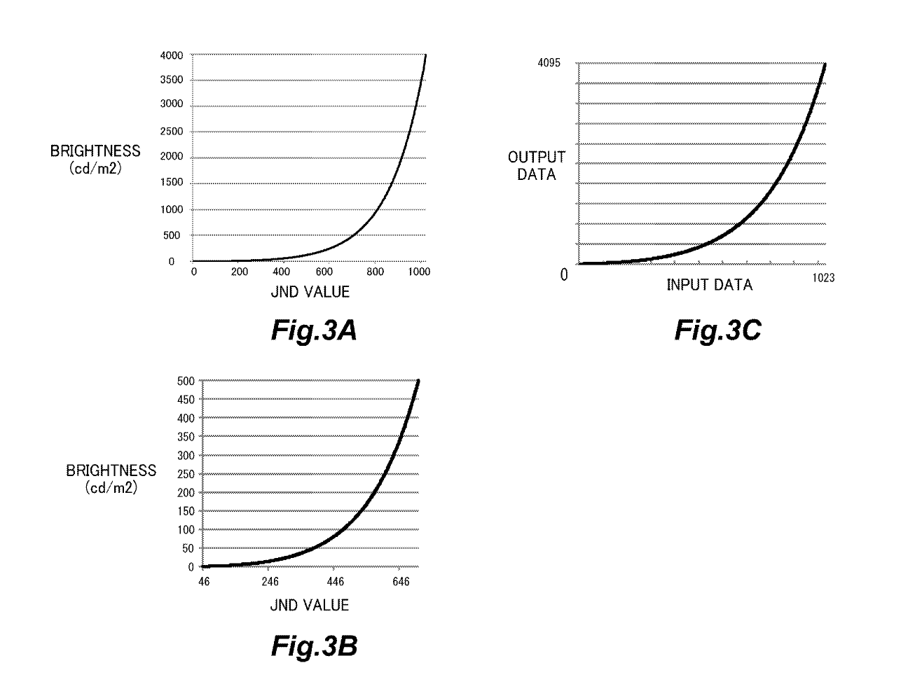

FIG. 3A shows a relationship between the JND value and the brightness determined by the DICOM standard, which is a standard of medical image apparatuses. The graph is FIG. 3A is called a “DICOM curve”. The abscissa in FIG. 3A indicates the JND value, and the ordinate indicates the brightness. According to this standard, the range of the JND value is 1 to 1023, and the range of the brightness is 0.05 cd/m² to 4000 cd/m². However, the range of the brightness of the display apparatus that uses a liquid crystal panel is limited. For example, if the range of the brightness of the display apparatus is 0.5 to 500 cd/m², the range of the JND value is 46 to 706, and the resolution is 640. On the other hand, if the brightness of the display apparatus is double, that is in a 1 to 1000 cd/m² range, then the range of the JND value is 71 to 811, and the resolution is 730.

As the brightness of the display apparatus is increased, the range of the JND value is widened, and the resolution increases accordingly, but as FIG. 3A shows, the profile of the relationship between the JND value and the brightness is different depending on the range of brightness. Therefore the JND value corresponding to the range of brightness of the display apparatus is standardized to a value in the range of the minimum value 0 to the maximum value 1023. The range of the brightness is also standardized to a value in the range of the minimum value 0 to the maximum value 4095. Thereby, the input data (gradation values 0 to 1023) is converted into output data (brightness value 0 to 4095).

For example, in Example 1, it is assumed that the range of brightness of a normal block is 0.5 to 500 cd/m² (first brightness range). Here “normal block” refers to a block corresponding to a sub-region which is not specified as a region of interest. In a block corresponding to a sub-region which is not specified as a region of interest, the brightness of the block is controlled to a value within a first range in accordance with the luminosity of the sub-region by local dimming. The range of the JND value corresponding to the first brightness range is 46 to 706.

FIG. 3B is a graph showing the relationship between the JND value and the brightness generated by extracting the JND value range of 46 to 706 in FIG. 3A. In FIG. 3B, the abscissa indicates the JND value, and the ordinate indicates the brightness. The values are normalized by assigning the JND value=46 in FIG. 3B to the minimum value 0 of the input gradation, and the JND value=706 to the maximum value 1023 of the input gradation. When the input gradation is between the minimum value and the maximum value, that is, a value between 1 and 1022, this value is assigned to a JND value in the 46 to 706 range. If the input gradation is 499, for example, the corresponding JND value is (706−46)/1024×499≅321.6. Therefore the closest JND value 322 is assigned. An output value is a value generated by normalizing the brightness (a value in a range of 0.5 to 500 cd/m²) corresponding to the JND value 322 to a value in the 0 to 4095 range.

If the input gradation is 500, on the other hand, the corresponding JND value is (706−46)/1024×500≅322.2, and just like the case when the input gradation is 499, the closest JND value 322 is assigned. Therefore the corresponding output value is a value generated by normalizing the brightness corresponding to the JND value 322 to a value in the 0 to 4095 range, and is a value the same as the case when the input gradation is 499.

As described above, the input value is converted and output based on the correspondence between the JND value and the brightness in accordance of the brightness of the block of the backlight. FIG. 3C is a graph showing the relationship between the converted input value and the output value. The data correction unit 9 corrects the image data of a sub-region corresponding to a normal block using a conversion table based on this correspondence. In the same manner, the control unit 5 has a conversion table that is applied to the image data of a sub-region (region of interest) corresponding to a boost block, and the data correction unit 9 corrects the image data of the region of interest using this conversion table. In Example 1, the brightness of the boost block is assumed to be double that of the brightness of a normal block. In other words, the range of the brightness of the boost block is 1 to 1000 cd/m² (second brightness range), and the possible range of the JND value is 71 to 811.

The second brightness range is a range that is wider than the first brightness range on the higher brightness side. The minimum brightness and the maximum brightness of the second brightness range are both higher than the minimum brightness and the maximum brightness of the first brightness range respectively. The conversion tables that are applied to the image of the region of interest are: a conversion table created by corresponding the JND values in this range and the input value in the 0 to 1023 range; and a conversion table created by corresponding the brightness in the second brightness range and the output values in the 0 to 4095 range. These conversion tables are created in advance, stored in a storage region of the control unit 5 or in a storage apparatus that is not illustrated, and read by the control unit 5 when necessary.

In Example 1, the output value is a 12 bit value of which number of bits is higher than the number of bits of the input value, which is 10 bits. This is because, if the number of bits is low, the brightness difference becomes small, especially when a low gradation image is input, in the above mentioned normalization, and the resolution of the output brightness value becomes insufficient; then display at high resolution becomes impossible, even if the possible range of the JND values is widened by increasing the brightness range, and the effect of the present invention may not be demonstrated to the maximum. The control unit 5 sends the conversion table to be applied to the sub-region corresponding to a normal block and the conversion table to be applied to the sub-region corresponding to a boost block, created as described above, to the data correction unit 9 as the data for correction.

The diagnostic region determination unit 6 divides the input image into regions corresponding to the blocks of the backlight, and determines whether each sub-region is a background region or a diagnostic region. The determination method, for example, compares the maximum value of the pixel values in each sub-region, acquired by the characteristic value detection unit 4 in a previous step, with a threshold. The diagnostic region determination unit 6 determines a sub-region, of which maximum value of the pixel value is the threshold or more, as the diagnostic region, and determines a sub-division, of which maximum value of the pixel values is less than the threshold, as the background region. The diagnostic region determination unit 6 sends the determination result to the target brightness determination unit 7 in a subsequent step. For example, if the characteristic value of each sub-region received from the characteristic value detection unit 4 is as shown in FIG. 2B, and the threshold for determination is 90, then the result of determining whether each sub-region is a diagnostic region or the background region is as shown in FIG. 2C.

In FIG. 2C, the diagnostic region is indicated by “1”, and the background region is indicated by “0”. The regions determined as the diagnostic regions in FIG. 2C are in the upper part of the image where the GUI (menu image) exists, and in the region where the captured image exists. If the characteristic value detection unit 4 acquires the number of pixels, which are brighter than a certain standard, as the characteristic value, a threshold to determine the number of these pixels is set, and a sub-region, of which number of pixels is the threshold or more, is regarded as the diagnostic region, and a sub-region, of which number of pixels is less than the threshold, is regarded as the background region. The method for determining whether the region is the diagnostic region or the background region, based on the characteristic value, is not limited to this method.

The target brightness determination unit 7 determines the brightness of the backlight for each block based on the determination result of the diagnostic region determination unit 6, the coordinates of the region of interest received from the control unit 5, and the set value of the brightness of the backlight in the corresponding block for each region type of the diagnostic region, the background region and the region of interest. The brightness of the block corresponding to the background region is set to be darker than the brightness of the block corresponding to the diagnostic region. As a result, the contrast improves. The brightness of the boost block is set to be brighter than the brightness of the normal block.

For example, it is assumed that the brightness level of the block corresponding to the background region, which is not specified as the region of interest, is controlled to 1, and the brightness level of the block corresponding to the diagnostic region, which is not specified as the region of interest, is controlled to 2 by the local dimming control. In Example 1, the brightness level, which is set to the sub-region to be specified as the region of interest by the local dimming control, is set to be higher than the sub-region that is not set as the region of interest (brightness level is set to double, for example). As a result, by the local dimming control, the brightness level of the block corresponding to the background region, which is specified as the region of interest, is controlled to 2, and the brightness level of the block corresponding to the diagnostic region, which is specified as the region of interest, is controlled to 4. In the case when the background region is never specified as the region of interest, an error message may be displayed, for example, if the background region is specified as the region of interest, so that the user can set the region of interest again. In this case, it is unnecessary to set the above mentioned “brightness level corresponding to the background region which is specified as the region of interest”.

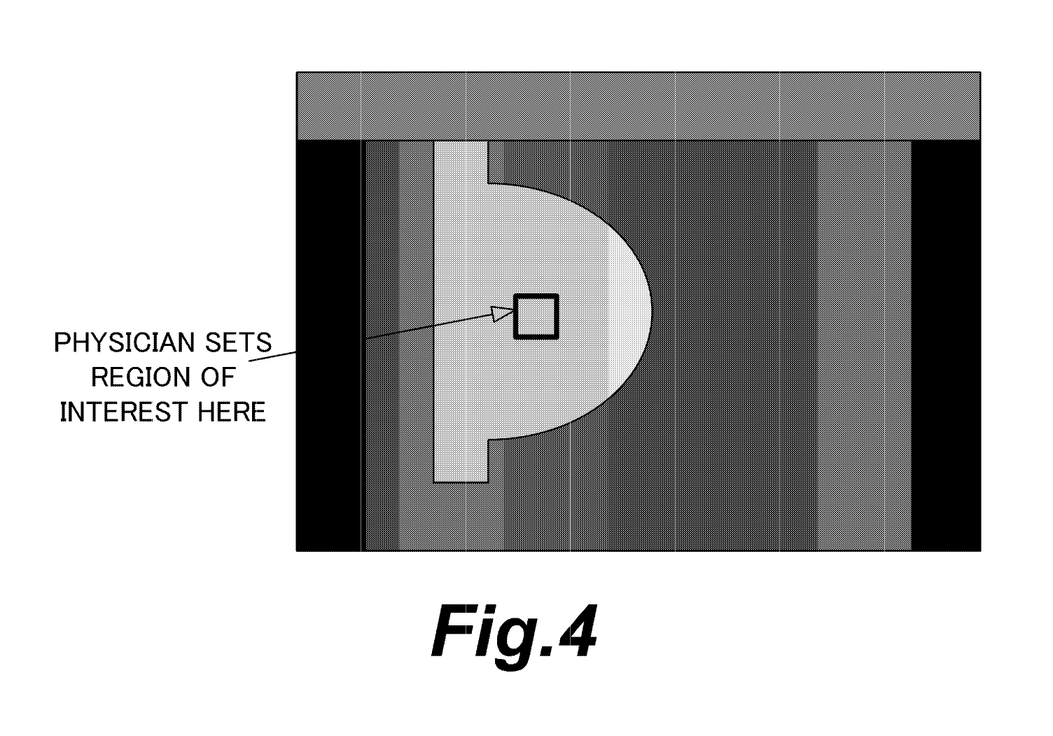

By increasing the brightness of the block corresponding to the region of interest to be higher than the normal brightness, the possible range of the JND value increases in the region of interest. For example, it is assumed that the user (e.g. physician or image reader) inputs an instruction to specify a region of interest in the viewer application, as shown in FIG. 4(a), while diagnosing using the image in FIG. 2A. The input is performed using an input unit, such as a mouse or keyboard, connected to the workstation where the viewer application is running. The viewer application sends the coordinates information on the region of interest specified by the user to the display apparatus. When the block of the backlight corresponding to the region of interest is set to a boost block, a brightness higher than the normal block is set.

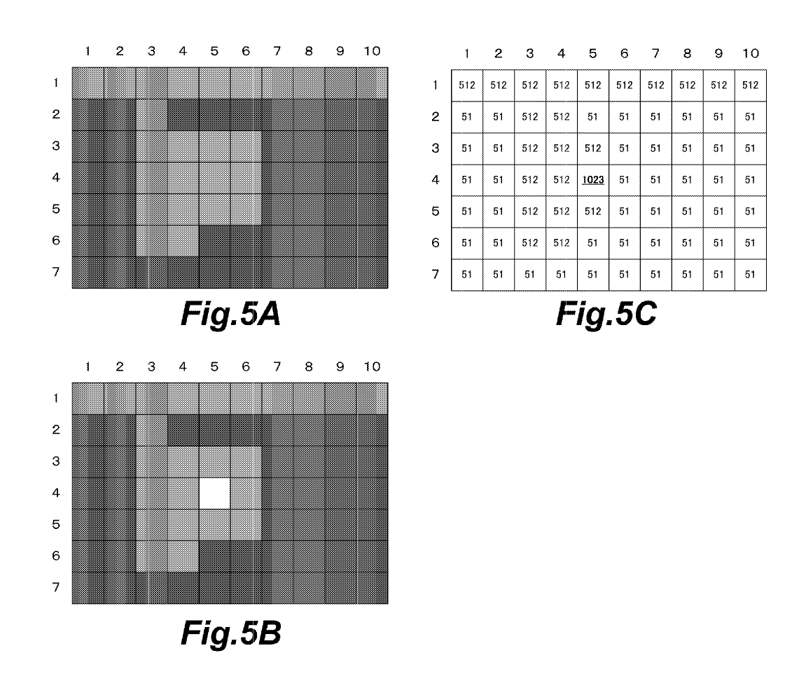

FIG. 5A shows the brightness of each block of the backlight before setting the boost block. FIG. 5B shows the brightness of each block of the backlight after setting the boost block. The block at coordinates (5, 4) before setting the boost block is lit at the same brightness as the brightness of the peripheral blocks corresponding to the diagnostic region, but is lit at a brightness higher than the brightness of the peripheral blocks corresponding to the diagnostic region when the block is specified to the boost block, as shown in FIG. 5B.

In Example 1, it is assumed that the brightness of the backlight of a block corresponding to each region type (background region, diagnostic region, region of interest), that is set by the control unit 5, is as follows. The brightness of the block corresponding to the diagnostic region is 512, the brightness of the block corresponding to the background region is 51, and the brightness of the boost block (boost brightness) is 1023. In this case, the brightness of the backlight of each block is as shown in FIG. 5C. Example 1 assumes that the backlight is lit at the maximum brightness when the set value of the brightness is 1023, and the backlight is not lit when the set value of the brightness is 0. The target brightness determination unit 7 sends the brightness value of the backlight, which was determined for each block like this, to the control value determination unit 8.

The control value determination unit 8 determines the control value of the backlight so that each block of the backlight is lit at the brightness determined by the target brightness determination unit 7. For example, if the light source of the backlight is constituted by LEDs and the brightness of the LEDs is controlled by the pulse width modulation (PWM) method, the control value determination unit 8 determines the pulse width, that is the lighting time, as the backlight control value for each block, and sends the backlight control value for each block to the backlight module unit 3.

The data correction unit 9 corrects the input image data using the data for correction which was acquired from the control unit 5. If the region of interest is specified, the data correction unit 9 receives the coordinates of the region of interest from the control unit 5, and corrects the image data on the region of interest using the data for correction for the region of interest. The data correction unit 9 outputs the corrected image data to the liquid crystal panel unit 2.

The above is the description on each function of the display apparatus 1.

The workstation 13 will now be described.

The data input/output unit 14 is connected to a hospital network (not illustrated), and acquires the captured images and information on image capturing conditions acquired from a data storage server (not illustrated) based on modality. The data input/output unit 14 is also connected to the viewer 15, so as to accept a request for a captured image from the viewer 15, and send a captured image and information on image capturing conditions received via the network to the viewer 15.

The input apparatus 17 is an apparatus for the user to input an instruction to the workstation 13 by operating a GUI, such as a menu, displayed on the display apparatus 1. The information on the user operation is sent to the viewer 15. The input apparatus 17 is a keyboard, a mouse or the like. The viewer 15 will be described next.

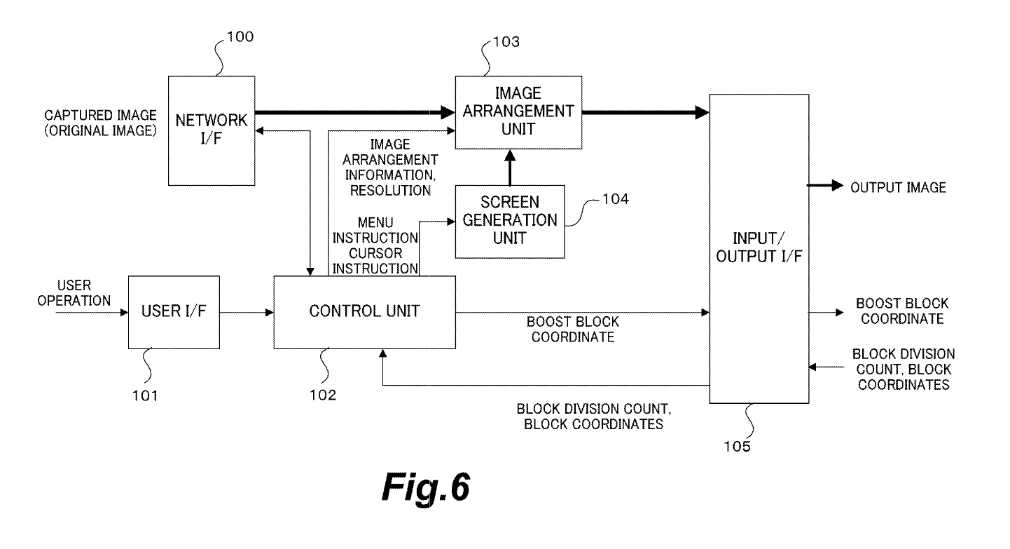

FIG. 6 shows the functional blocks of the viewer 15. The viewer 15 is constituted by a network I/F 100, a user I/F 101, a control unit 102, an image arrangement unit 103, a screen generation unit 104, and an input/output I/F 105. The viewer 15 may be implemented by hardware that has the functions of each block, or a part or all of the functions of these blocks may be implemented by the CPU of the workstation 13 executing programs. The programs may be stored in a storage apparatus of the workstation 13 or may be supplied to the workstation 13 via a network or a storage medium. A part of the functions that generate a GUI may be implemented as the functions of an OS (Operating System) in which the programs are installed.

The network I/F 100 is connected with the data input/output unit 14, and outputs a request for a captured image or information on the image capturing conditions, and receive the captured image or information on the image capturing conditions. The network I/F 100 sends the received captured image to the image arrangement unit 103, and sends the information on the image capturing conditions to the control unit 102.

The user I/F 101 is connected with the input apparatus 17, and receives the operation by the user via a keyboard, mouse or the like, and sends the information on the operation content to the control unit 102. For example, if a physician (the user) selects an item on the menu using a mouse while the menu is displayed, the user I/F 101 sends the information on the movement of the cursor and the coordinates, where the mouse is clicked, to the control unit 102.

The control unit 102 receives the image capturing information of the captured image from the network I/F 100. Using the information on the resolution (the number of pixels) of the image, based on the image capturing information, the control unit 102 specifies whether the received image is output to the image arrangement unit 103 after converting the resolution or output to the image arrangement unit 103 with the same resolution. Then the control unit 102 specifies the screen generation unit 104 to generate an image for displaying a GUI, such as a menu and mouse cursor. The control unit 102 receives information on the number of blocks of the backlight and the coordinates of each block from the display apparatus 1 via the input/output I/F 105. If the user inputs an instruction to specify a region of interest, the control unit 102 determines a block of the backlight corresponding to the region of interest (boost block) based on the coordinates of the region of interest and the information on the coordinates of the block of the backlight of the display apparatus 1. The control unit 102 sends the information on the coordinates of the determined boost block to the display apparatus 1 as the boost block coordinates via the input/output I/F 105.

For example, it is assumed that the resolution (the number of pixels) of the liquid crystal panel unit 2 is 1920×1080, the block division count of the backlight is 10 in the horizontal direction and 7 in the vertical direction, as shown in FIG. 2B. The number of pixels in a region of an image corresponding to one block of the backlight (sub-region) is 192 pixels in the horizontal direction and 154 pixels in the vertical direction. Various methods are possible as the operation for the user to specify the region of interest, but an operation of specifying one point will be described as an example. In this case, a sub-region that includes the one point specified by the user are regarded as a region of interest. For example, if the coordinates of the point specified by the user is (848, 526), then the coordinates of the region of interest are (5, 4) since 848/192≅4.4 in the horizontal direction, and 526/154≅3.4 in the vertical direction. The control unit 102 regards the block of the backlight corresponding to the sub-region at the coordinates (5, 4) as the boost block. In the description of this example, the sub-region, in which the point specified by the user exists, is regarded as the region of interest, but the sub-regions around the sub-region, in which the point specified by the user exists, may also be regarded as the region of interest. If the position of the point specified by the user is distant from the center of the sub-region, the sub-region close to the point specified by the user may also be regarded as the region of interest. If the region of interest is constituted by a plurality of sub-regions, a plurality of boost blocks exist.

The image arrangement unit 103 receives a captured image from the network I/F 100, and receives the viewer screen from the screen generation unit 104. The image arrangement unit 103 also receives the output resolution of the captured image, the arrangement information on the viewer screen and the captured image, and the information on the format of the input image and the image to be displayed, from the control unit 102. Here the “format of an image” refers to an image file format, such as RAW image, bit map image and tiff image, for example. The image arrangement unit 103 enlarges or reduces the received captured image without changing the aspect ratio, in accordance with the output resolution and the arrangement information of the viewer image and the captured image, and combines the enlarged or reduced image with the viewer screen. The image arrangement unit 103 outputs the combined image to the input/output I/F 105 in the subsequent step.

The screen generation unit 104 generates a viewer screen, as shown in FIG. 2A, and sends this viewer screen to the image arrangement unit 103. If an instruction to display a GUI, such as a menu, in accordance with the user operation, is received from the control unit 102, the screen generation unit 104 generates an image of the GUI to be added to the viewer screen, and sends the image of the GUI to the image arrangement unit 103. The size of the viewer screen is set by the control unit 102.

The input/output I/F 105 is connected with the image arrangement unit 103 and the control unit 102. The input/output I/F 105 is connected with the image and data input/output unit 16. The input/output I/F 105 outputs the image, input from the image arrangement unit 103, and the coordinates of the region of interest input from the control unit 102, to the display apparatus 1 via the image and data input/output unit 16. The input/output I/F 105, on the other hand, receives the block division count of the backlight and information on the coordinates of the block from the display apparatus 1 via the image and data input/output unit 16, and sends this to the control unit 102. The above is the description on the functional blocks of the viewer 15.

The image and data input/output unit 16 of the workstation 13 is connected with the viewer 15 and the display apparatus 1. The image and data input/output unit 16 outputs the image and the coordinates of the region of interest, input from the viewer 15, to the display apparatus 1. Further, the image and data input/output unit 16 sends the block division count of the backlight and information on the coordinates of the block input from the display apparatus 1 to the viewer 15. The display apparatus 1 and the workstation 13 are connected via cable or wireless, so as to transmit/receive images and data. The standard cable connection is a display port, for example. In this case, data is transmitted or received via an AUX channel cabled with the display port. The connection standard is not limited to this, but may be HDMI® (High Definition Multimedia Interface) or LAN (Local Area Network), for example.

According to the display system of Example 1, a possible range of the JND value in the region of interest is widened by setting the brightness of the block of the backlight corresponding to the region of interest specified by the user to be higher than the brightness of the normal block. Thereby display with high gradation resolution can be performed in the region of interest, and a highly accurate diagnosis can be performed. Further, the normal blocks of the backlight, other than the region of interest, are lit at a brightness lower than the block of the backlight corresponding to the region of interest, hence the generation of halos can be suppressed even if the region of interest is set to high brightness. Moreover, an increase in power consumption can be suppressed since the brightness of the normal block is not increased.

### Example 2

In Example 1, information on the block of the backlight corresponding to the region of interest specified by the user using the viewer (boost block) is notified to the display apparatus, and the display apparatus sets the brightness of the backlight of the boost block to be higher than the brightness of the normal block. Thereby the possible range of the JND value in the region of interest can be widened and the region of special interest to the physician can be displayed at high gradation resolution, hence the generation of halos and an increase in power consumption can be suppressed, and interference and power consumption can be reduced. In Example 2, on the other hand, an image of the region of interest specified by the user is enlarged and displayed, and the brightness of the block of the backlight corresponding to the enlarged region of interest is set to be higher than the normal block as the boost block. As a result, the accuracy of image diagnosis in the region of interest can be further improved.

The functional block diagram of the display system according to Example 2 is roughly the same as FIG. 1 of Example 1. The only difference is the viewer of the workstation. So the difference in Example 2 from Example 1 on the viewer of the workstation will be mainly described. In Example 2, the workstation is denoted with 200 and the viewer is denoted with 201 in order to distinguish workstation 13 and the viewer 15 of Example 1.

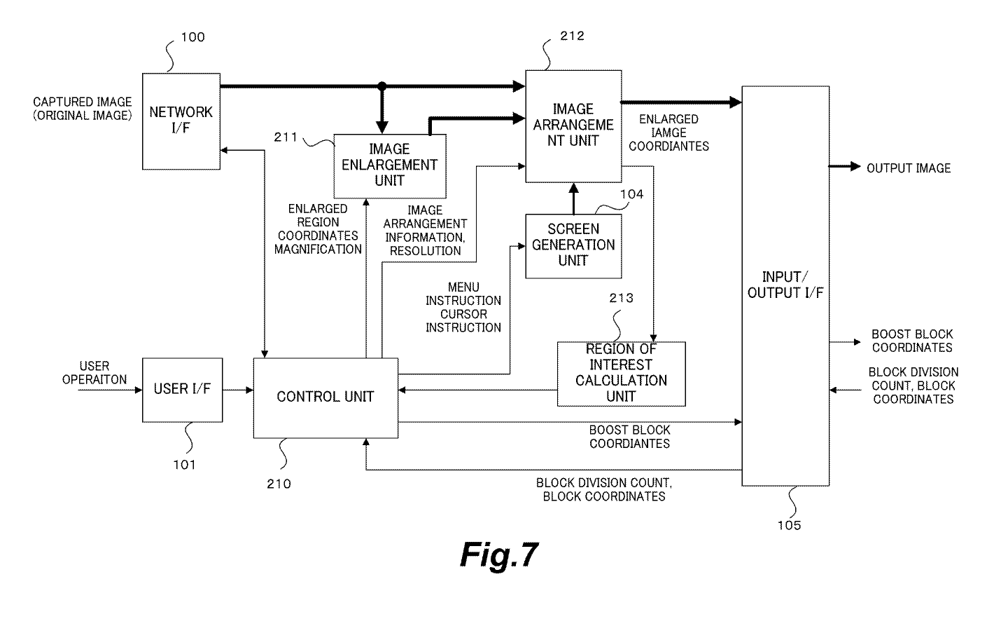

FIG. 7 is a functional block diagram of the viewer 201. The viewer 201 is constituted by the network I/F 100, the user I/F 101, a control unit 210, an image enlargement unit 211, an image arrangement unit 212, the screen generation unit 104, a region of interest calculation unit 213, and the input/output I/F 105. The description of the functions already described in Example 1 will be omitted.

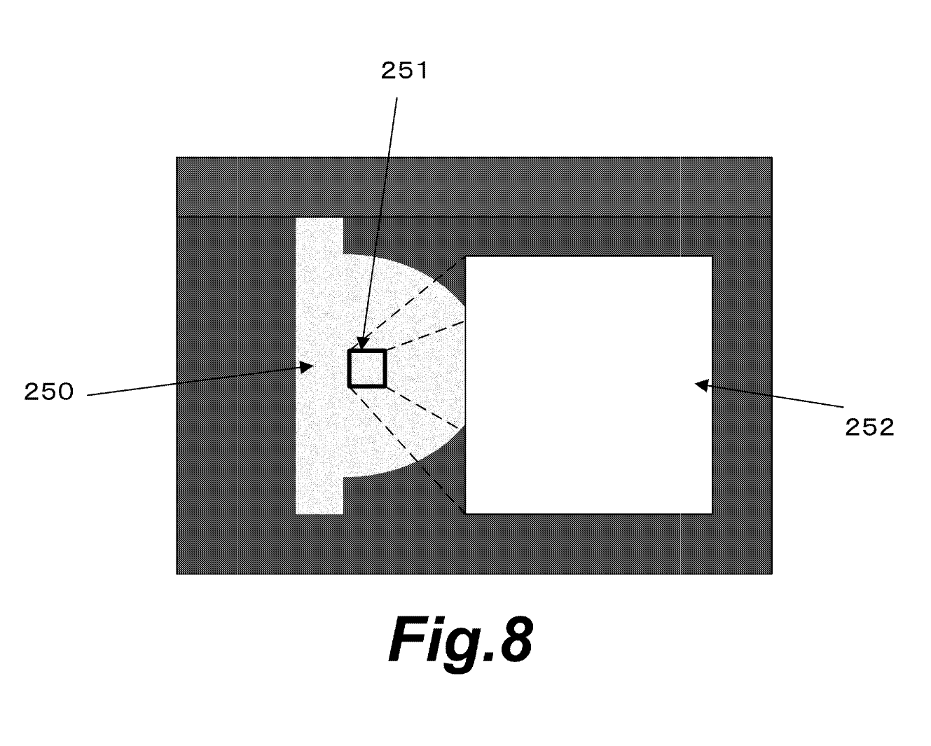

In Example 2, if a region of interest is specified by the user, as shown in FIG. 4, an image generated by enlarging the specified region of interest is superimposed on the captured image and displayed in this state, as shown in FIG. 8, and the brightness of the block of the backlight corresponding to the region of the enlarged image is increased to be higher than the normal block. In FIG. 8, the object 250 is an object image included in the captured image, the region of interest 251 is a region of interest specified by the user, and the enlarged image 252 is an image generated by enlarging the region of interest 251 four times vertically and horizontally. When an instruction to specify a region of interest is received from the user I/F 101, the control unit 210 sends information on the position of the region and magnification to the image enlargement unit 211. In the example of FIG. 8, the control unit 210 sends the coordinates of the pixels at 4 vertexes of the rectangular region of interest 251, and information that magnification is ×4 to the image enlargement unit 211. The control unit 210 also receives the coordinates of the block of the backlight corresponding to the enlarged image from the region of interest calculation unit 213. The control unit 210 outputs the coordinates of the received block to the input/output I/F 105 as the boost block coordinates.

The image enlargement unit 211 receives the coordinates of the region of interest to be enlarged and the magnification from the control unit 210. The image enlargement unit 211 receives an input image from the network I/F 100, extracts the image of the region of interest, and generates an enlarged image thereof. The image enlargement unit 211 sends the generated enlarged image to the image arrangement unit 212.

Just like the image arrangement unit 103 of Example 1, the image arrangement unit 212 combines the captured image received from the network I/F 100, the enlarged image received from the image enlargement unit 211, and the images constituting the GUI of the viewer screen received from the screen generation unit 104. The image arrangement unit 212 acquires the arrangement information on the captured image, the enlarged image and the viewer screen from the control unit 210, and combines the captured image and the enlarged image on the viewer screen in accordance with the arrangement information. The image arrangement unit 212 sends the combined image to the input/output I/F 105. The image arrangement unit 212 sends the information on the coordinates of the enlarged image (for example, coordinates of the pixels at 4 vertexes if the enlarged image is a rectangle) to the region of interest calculation unit 213.

The region of interest calculation unit 213 calculates the coordinates of the block of the backlight corresponding to the enlarged image based on the coordinates of the enlarged image received from the image arrangement unit 212. The region of interest calculation unit 213 sends the coordinates of the calculated block to the control unit 210.

A region of interest is constituted by one or a plurality of sub-region(s), and each sub-region is a region of the image corresponding to each block, hence if the magnification is a multiple integer, an area of the enlarged image is a multiple integer of an area of the sub-region. If the image arrangement unit 212 arranges such that the positions of the vertexes of the enlarged image match with the vertexes of the sub-region, then the enlarged image is constituted by an integral number of sub-regions. Therefore the block corresponding to the enlarged image is a plurality of blocks corresponding to a plurality of sub-images constituting the enlarged image.

The magnification of the enlarged image need not be a multiple integer, and the position where the enlarged image is disposed need not match with the position of the sub-regions. In this case, the blocks corresponding to a plurality of sub-regions, that include the enlarged image, may be regarded as the blocks corresponding to the enlarged image. A block corresponding to a sub-region, in which the ratio of the enlarged image is a threshold or more, may be regarded as a block corresponding to the enlarged image.

According to the display system of Example 2, the possible range of the JND value in the enlarged region can be widened by setting the brightness of the block of the backlight, corresponding to the enlarged image generated by enlarging the region of interest specified by the user, to be higher than the brightness of the normal block. Thereby the user can observe the region of interest more closely by enlarging the region, and the enlarged image can be displayed at high gradation resolution, and as a consequence, a highly accurate diagnosis can be performed. The normal blocks of the backlight, other than the region of interest, are lit at a brightness lower than the block of the backlight corresponding to the region of interest, hence even if the region of interest is set to high brightness, the generation of halos can be suppressed. Furthermore, an increase in power consumption can be suppressed since the brightness of the normal blocks is not increased.

### Example 3

In Example 1 and 2, the cases of applying the present invention to a display system having one display apparatus were described, but in Example 3, a case of applying the present invention to a display system having two display apparatuses (first display apparatus and second display apparatus) will be described. In Example 3, a region corresponding to a region of interest specified by the user in the first display apparatus (first region of interest), is searched in comparative images displayed in the second display apparatus (second region of interest). The block of the backlight corresponding to the first region of interest in the first display apparatus and the block of the backlight corresponding to the second region of interest in the second display apparatus are lit as the boost blocks at a brightness higher than the normal block. Thereby even when a comparative diagnosis is performed using two display apparatuses, the particular region of interest, which the physician wants to diagnose, can be displayed on both of the display apparatuses at high gradation resolution, while reducing interference and power consumption, which results in a highly accurate diagnosis.

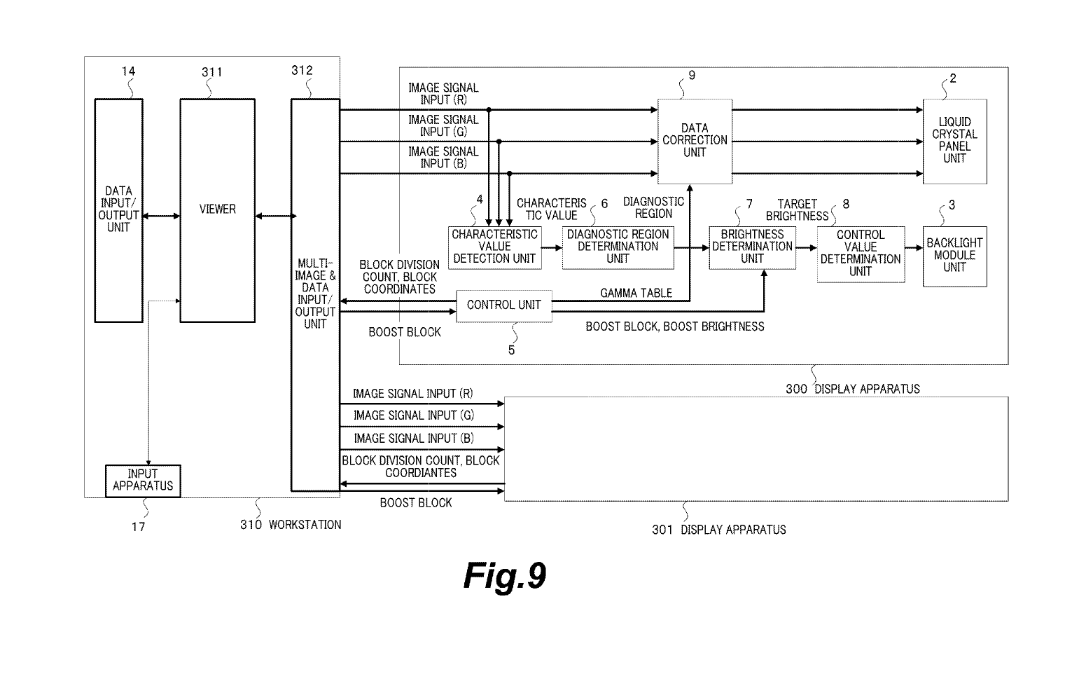

FIG. 9 is a functional block diagram of a display system according to Example 3. The display system in FIG. 9 is constituted by a display apparatus 300 and a display apparatus 301, and a workstation 310 for outputting capture image data to the display apparatus 300 and the display apparatus 301. The functional blocks of the display apparatus 300 are the same as those of the display apparatus 1 of Example 1, therefore description thereof will be omitted. The display apparatus 301 has the same configuration as the display apparatus 300.

The workstation 310 is constituted by the data input/output unit 14, the input apparatus 17, a viewer 311, and a multi-image and data input/output unit 312.

The viewer 311 outputs an image to the display apparatus 300 and the display apparatus 301 via the multi-image and data input/output unit 312. The viewer 311 determines the coordinates of the boost blocks of the display apparatus 300 and the display apparatus 301, and outputs the coordinates to the multi-image and data input/output unit 312. Furthermore, the viewer 311 receives information on the block division count of backlight and the coordinates of the blocks from the display apparatus 300 and the display apparatus 301 via the multi-image and data input/output unit 312. The viewer 311 acquires a captured image, to be displayed on the display apparatus 300 and the display apparatus 301, and information on the image capturing conditions, from the data input/output unit 14. The configuration of the viewer 311 will now be described.

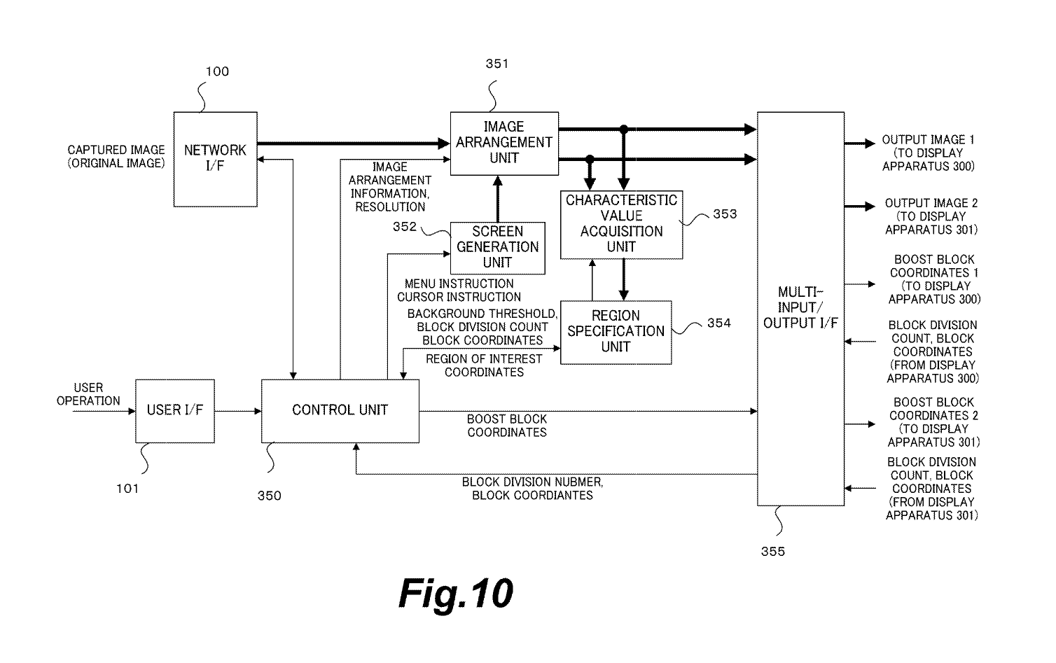

FIG. 10 shows the functional blocks of the viewer 311. The viewer 311 is constituted by the network I/F 100, the user I/F 101, a control unit 350, an image arrangement unit 351, a screen generation unit 352, a characteristic value acquisition unit 353, a region specification unit 354, and a multi-input/output I/F 355.

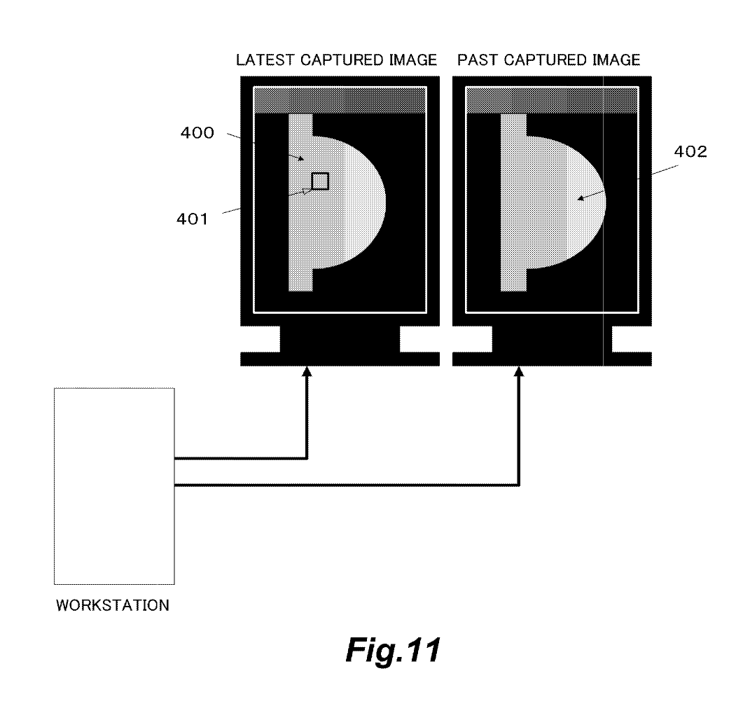

The control unit 350 acquires the two captured images via the network I/F 100 in accordance with the instruction of the user received via the user I/F 101. In Example 3, as shown in FIG. 11, it is assumed that images are compared and used for diagnosis using the two display apparatuses. For example, it is assumed that the latest captured image (first captured image) is displayed on one display apparatus (first display apparatus), and a past captured image (second captured image) is displayed on the other display apparatus (second display apparatus). An object 400 and an object 402 are the diagnosis target objects in the latest captured image and the past captured image respectively. A rectangular region 401 in FIG. 11 is a region of interest which the physician specified as a particular region of interest for diagnosis (first region of interest). In Example 3, a case when a region of interest is specified on the display apparatus 300 will be described as an example, but the same description is applicable to a case when a region of interest is specified on the display apparatus 301. Here it is assumed that a region of interest specified by the user on one of the display apparatuses is the first region of interest, and a region of interest corresponding to the first region of interest on the other display apparatus is the second region of interest.

When the display apparatus 300 receives information to specify a region of interest (region 401 in FIG. 11) from the user I/F 101, the control unit 350 determines the coordinates of the first region of interest. The method for determining the coordinates of the region of interest in accordance with the instruction of specifying a region of interest is the same as Example 1. The control unit 350 determines the coordinates of the first region of interest and the coordinates of the block of the backlight of the display apparatus 300 corresponding to the first region of interest (first boost block), and outputs the coordinates to the multi-input/output I/F 355 as the first boost block coordinates.

The control unit 350 sends the coordinates of the first region of interest, the number of blocks of the display apparatus 300 and the display apparatus 301, the coordinates of the block and the information on a background threshold of the first captured image and the second captured image to the region specification unit 354. The background threshold is a threshold for determining whether or not the region is a background portion other than a portion in which the image of an object is captured (object image), in the captured image, based on the characteristic value. If the input image is RAW image data, the control unit 350 determines the background threshold based on the image capturing information. For example, the control unit 350 calculates the reception intensity in a region where the object does not exist, based on the set values of the energy intensity of the radiation and sensitivity of the imaging plate, out of the image capturing information, and determines the background threshold from this value. The control unit 350 instructs the region specification unit 354 to determine a region (second region of interest) corresponding to the first region of interest in the past captured image displayed on the display apparatus 301. The method for the region specification unit 354, to determine the second region of interest, will be described later.

The control unit 350 receives the coordinates of the second region of interest in the past captured image from the region specification unit 354, and outputs the information on the block (second boost block) of the backlight of the display apparatus 301 corresponding to the second region of interest, to the multi-input/output I/F 355. The control unit 350 instructs the image arrangement unit 351 to display the two received captured images on the two display apparatuses respectively in accordance with the respective resolution (the number of pixels) of the two display apparatuses. The control unit 350 sends the resolutions of the display apparatus 300 and the display apparatus 301, the resolutions of the two received captured images, and the arrangement information of the captured images on the viewer screen generated by the screen generation unit 352 to the image arrangement unit 351. The control unit 350 instructs the screen generation unit 352 to generate an image constituting the GUI of the viewer, such as a menu, when the two captured images are displayed side-by-side.

The image arrangement unit 351 receives the latest captured image and the past captured image from the network I/F 100. The image arrangement unit 351 also receives the resolutions of the display apparatus 300 and the display apparatus 301, the resolutions of the two captured images, and the arrangement information of the captured images on the viewer screen. The image arrangement unit 351 enlarges or reduces the received captured image without changing the aspect ratio, in accordance with the resolutions of the two display apparatuses and the arrangement information of the captured images, and combines these images with the image of the viewer screen received from the screen generation unit 352. The image arrangement unit 351 outputs the combined image to the multi-input/output I/F 355 in a subsequent step.

The screen generation unit 352 creates an image constituting the GUI, such as a menu, for separately displaying the two captured images on the two display apparatuses based on the instruction of the control unit 350. The screen generation unit 352 outputs the created image constituting the GUI, such as a menu, to the image arrangement unit 351.

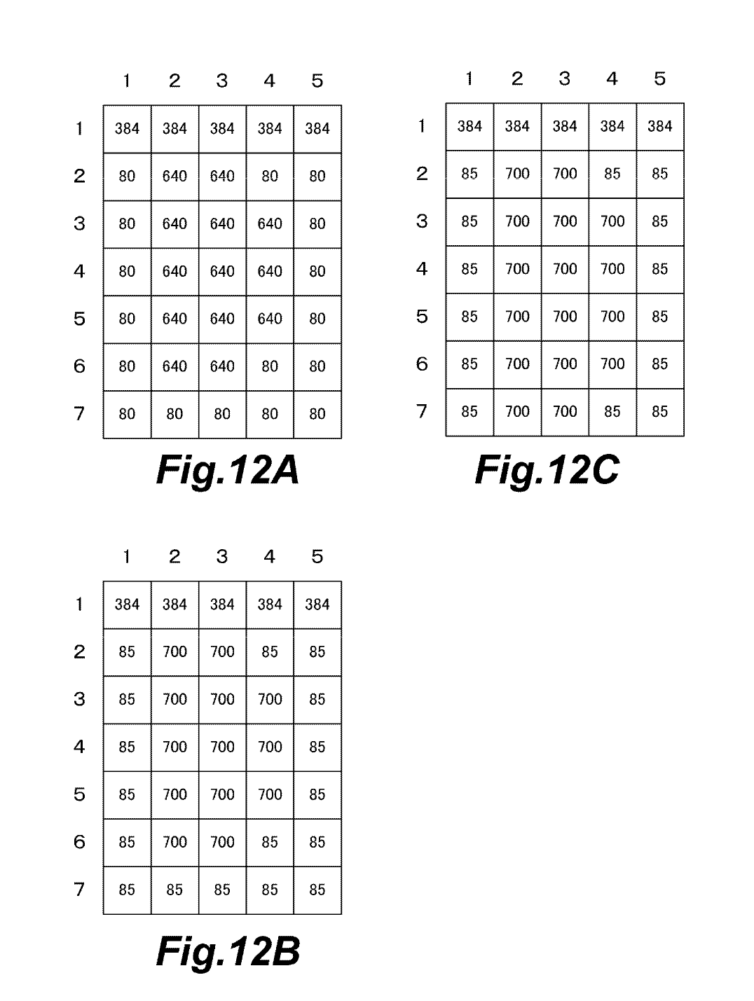

The characteristic value acquisition unit 353 acquires the characteristic values of the two captured images, which were output from the image arrangement unit 351, and outputs the characteristics values to the two display apparatuses. These characteristic values are used to determine the coordinates of the region of interest of the other display apparatus (second region of interest) corresponding to the region of interest specified by one of the display apparatuses (first region of interest) by the region specification unit 354. The characteristic value acquisition unit 353 divides the image into sub-regions according to the mode of the block division of the backlight of the display apparatus, and acquires the characteristic value for each sub-region. For example, it is assumed that the block division count of the backlight is 5 in the horizontal direction and 7 in the vertical direction, for both the display apparatus 300 and the display apparatus 301. Further, it is assumed that the captured image shown in FIG. 11 is output to the display apparatus 300 and the display apparatus 301. In this case, the characteristic values acquired by the characteristic value acquisition unit 353 become as shown in FIG. 12. FIG. 12A shows the characteristic values of the captured image output to the display apparatus 300, and FIG. 12B shows the characteristic values of the captured image output to the display apparatus 301. The characteristic value acquisition unit 353 acquires the block division count of the backlight and the coordinates of the blocks of the display apparatus 300 and the display apparatus 301 from the region specification unit 354, and acquires the characteristic values based on this information. The characteristic value acquisition unit 353 sends the acquired characteristic values to the region specification unit 354.

The region specification unit 354 determines the second region of interest corresponding to the first region of interest on the display apparatus 301 (second display apparatus) based on the information on the first region of interest specified on the display apparatus 300 (first display apparatus). The region specification unit 354 sends the information on the second region of interest to the control unit 350. The region specification unit 354 determines an object region, which is a region excluding the background region and the menu region (sub-region constituting by GUI image, such as a menu), from the captured image, based on the characteristic values acquired from the characteristic value acquisition unit 353.

Based on the information on the background thresholds of the captured image on the display apparatus 300 (first captured image) and the captured image on the display apparatus 301 (second captured image), which were received from the control unit 350, the region specification unit 354 determines the background regions of the first captured image and the second captured image. For example, the region specification unit 354 regards a sub-region, of which characteristic value is a background threshold or less, as the background region. The region specification unit 354 also regards a sub-region, of which characteristic value is greater than a background threshold and is a predetermined threshold or less, as the menu region. This threshold is determined based on the pixel values or the like of the image constituting the GUI of the viewer application. Here it is assumed that the GUI of the viewer application is constituted by an image of which pixel values are smaller than the normal pixel values of the object image in the captured image. For example, a threshold used for determining whether the region is the diagnostic region or the background region in Example 1 may be used. In other words, among the sub-regions which were determined as the background region in Example 1, each sub-region, of which characteristic value is greater than the background threshold, can be determined as the menu region.

The region specification unit 354 determines the maximum value of the size of the object region in the horizontal direction and the maximum value of the size thereof in the vertical direction in sub-region units. The region specification unit 354 also determines the coordinates of the sub-region corresponding to the upper left corner position of the object region. For example, in the case of FIG. 12A, the size of the object region in the horizontal direction is the maximum in the portion from coordinate 2 to coordinate 4, hence the maximum value of the size in the horizontal direction is the size of three sub-regions. The maximum value of the size in the vertical direction is the portion from coordinate 2 to coordinate 6, which is the size of five sub-regions. The coordinates of the sub-region at the upper left corner of the object region are (2, 2). The maximum value of the size of the object region in the horizontal direction, the maximum value of the size thereof in the vertical direction, and the coordinates of the sub-region at the upper left corner of the object region in FIG. 12B are the same as FIG. 12A.

The region specification unit 354 determines the coordinates of the block of the backlight corresponding to the first region of interest (first boost block) on the display apparatus 300, based on the coordinates of the region of interest (first region of interest) on the display apparatus 300 acquired from the control unit 350.

If the size of the object region and the coordinates of the sub-region at the upper left corner on the first display apparatus and those of the second display apparatus are all the same as the cases of FIG. 12A and FIG. 12B, the region specification unit 354 regards the coordinates of the first region of interest on the display apparatus 300 as the coordinates of the second region of interest on the corresponding display apparatus 301. Then the region specification unit 354 regards the block of the backlight on the display apparatus 301 corresponding to the second region of interest as the second boost block. In other words, in this case, the coordinates of the second boost block are the same as the coordinates of the first boost block.

If the size and position of the object region in the captured image on the display apparatus 301 are different from the size and position of the object in the captured image on the display apparatus 300, as shown in FIG. 12C, on the other hand, the second region of interest and the second boost block are determined as follows. In FIG. 12C, the maximum value of the size of the object region in the horizontal direction in the captured image on the display apparatus 301 is the portion from coordinate 2 to coordinate 4, which is the size of three sub-regions. The maximum value of the size in the vertical direction is the portion from coordinate 2 to coordinate 7, which is the size of six sub-regions. The size of the object region in the vertical direction in the captured image on the display apparatus 301 is 1.2 times (=6÷5) of the size of the object region in the vertical direction in the captured image on the display apparatus 300. In this case, the region specification unit 354 determines a value generated by multiplying the coordinates of the first region of interest on the display apparatus 300 by 1.2 in the vertical direction as the coordinate of the second region of interest on the display apparatus 301. At this time, the coordinates of the sub-region at the upper left corner of the object region is used as the offset value.

For example, it is assumed that the coordinates of the first region of interest on the display apparatus 300 is (3, 4) in FIG. 12A. Since the coordinates of the sub-region at the upper left corner of the object region are (2, 2), and the coordinates of the first region of interest on the display apparatus 300 are (3, 4), the coordinates of the second region of interest in the vertical direction on the display apparatus 301 is determined by the following Expression 1.

(coordinate of first region of interest−coordinate of upper left corner of first region of interest)×magnification of length+coordinates of upper left corner of second region of interest (Expression 1)

In the case of the above example, the coordinate of the second region of interest in the vertical direction is (4−2)×1.2+2=4.4. In this case, the second region of interest exists between coordinates (3, 4) and (3, 5) in the captured image on the display apparatus 301, hence the coordinates of the second boost block corresponding to the second region of interest are determined as (3, 4) and (3, 5). The region specification unit 354 sends the coordinates of the second boost block of the display apparatus 301 determined in this way to the control unit 350.

In the above example, if the coordinates of the second region of interest are not on lattice points of the region of interest on the second display apparatus 301 (coordinates are not integers), the block group corresponding to the sub-region group, including the second region of interest, is regarded as the second boost block. However, a block corresponding to any of the sub-regions having a portion common with the second region of interest may be regarded as the second boost block. In this case, a block corresponding to the sub-region, which shares the largest area with the second region of interest, for example, may be regarded as the second boost block. A block corresponding to the sub-region, which includes at least a part of the second region of interest, may be regarded as the second boost block.

In the above example, the case when the two display apparatuses have a same size of the object region in the horizontal direction was described, but each may have different sizes of the object region in the horizontal direction as well. In this case, a block group corresponding to the sub-region group, including the second region of interest, may be regarded as the second boost block, or a block to be the second boost block may be determined based on the size of the area shared with the second region of interest, as mentioned above.

In the above example, the case when the block division of the backlight of the first display apparatus 300 is the same as that of the second display apparatus 301 was described, but the block division may be different between the two display apparatuses. In this case, the region specification unit 354 can determine the coordinates of the second region of interest corresponding to the first region of interest using the information on the difference of the block division counts between the two display apparatuses (e.g. ratio of block division counts in the horizontal direction; ratio of block division counts in the vertical direction). For example, if the block division count of the first display apparatus 300 in the horizontal direction is 7 and the block division count of the second display apparatus 301 in the horizontal direction is 14, then Expression 1 can be modified as follows.

(coordinate of the first region of interest−coordinate of upper left corner on the first region of interest)×division count ratio+coordinate of upper left corner of second region of interest (Expression 2)

Here the division count ratio in the above example is 14/7=2.

The multi-input/output I/F 355 receives the captured images, output from the image arrangement unit 351, to be displayed on the display apparatus 300 and the display apparatus 301, and sends the captured images to the multi-image and data input/output unit 312. The multi-input/output I/F 355 also receives the boost block coordinates on the display apparatus 300 and the display apparatus 301 from the control unit 350, and sends the boost block coordinates to the multi-image and data input/output unit 312. The control unit 350 receives the block division counts and the coordinates of the blocks of the backlight of the display apparatus 300 and the display apparatus 301 via the multi-image and data input/output unit 312.

According to the display system of Example 3, the block corresponding to the first region of interest specified by the user on the first display apparatus and the block corresponding to the second region of interest, which corresponds to the first region of interest on the second display apparatus, are lit at a brightness higher than the normal block. Therefore when two types of captured images are displayed on the two display apparatuses, are compared and used for diagnosis, the possible range of JND value can be widened in both the first region of interest and the second region of interest. As a result, on both of the two display apparatuses, display at high gradation resolution can be performed in the region of interest, and therefore diagnosis with high accuracy becomes possible, and interference caused by halos and an increase in power consumption can be suppressed.

In each of the above examples, image data is corrected using the conversion table based on the relationship between the JND value and the brightness, but the conversion table used for correction of the image data is not limited to this. The characteristic of being able to display the image at high gradation resolution by increasing the brightness of the backlight does not depend only on the conversion table used for correction of the image data. However, when a monochrome (grayscale) medical image acquired by a modality is displayed, it is preferable to use a conversion table based on the relationship between the JND value and brightness, since the grayscale display, with a more natural gradation characteristic, can be implemented.

In Example 3, an example when the present invention is applied to the display system in which the two display apparatuses are disposed side-by-side was described, but the present invention can also be applied to a display system in which three or more display apparatuses are disposed side-by-side. In this case, when the user specifies a region of interest in a captured image disposed on one of the display apparatuses, the regions of interest displayed on the other display apparatuses corresponding to this region of interest can be determined by the same method as Example 3.

In each of the above examples, the user specifies one point for the operation to specify a region of interest, but the present invention is not limited to this. For example, the user may specify a region of interest by drawing a square, a circle or any other shape. In this case, the region drawn by the user, or a sub-region that includes at least a part of this region, or a sub-region included in the region drawn by the user, can be regarded as the region of interest.

In Example 3, an example of determining the size of the object region in the sub-region units was described, but the present invention is not limited to this. For example, the size of the object region may be determined in pixel units or in units finer or rougher than the sub-region.

In each of the above example, when a boost block corresponds to a sub-region specified as the region of interest, the brightness of this boost block is set to a brightness multiplied by a predetermined magnification with respect to the normal block corresponding to a sub-region that is not specified as the region of interest. However, the method of increasing the brightness of the boost block with respect to the brightness of the normal block is not limited to this. For example, for a normal block, the brightness of each block is set within a first brightness range in accordance with the characteristic value of the sub-region, and for the boost block, the brightness is set in a second brightness range, which is wider than the first brightness range at least on the higher brightness side, in accordance with the characteristic value of the sub-region. Or in the boost block, a predetermined brightness may be offset from the normal block. For example, when the brightness level of the background region is 1 and the brightness level of the diagnostic region is 2 in a normal block, the brightness level of the background region is set to 2 and the brightness level of the diagnostic region is set to 3 in the boost block (offset of 1). In the above example, the brightness level is variably controlled by local dimming to two types in accordance with the characteristic value of the sub-region, but two or more types of variable values may be used for the brightness level. In this case, in the boost block corresponding to the region of interest and the normal block, setting should be such that the brightness level to be set using local dimming is higher in the boost block than in the normal block, even if the characteristic values of the sub-regions are the same. The brightness of the boost block corresponding to the region of interest may be set to a fixed value (e.g. maximum brightness that can be set for backlight).

In each of the above examples, the workstation determines the position of the boost block based on the information on the region of interest, and outputs this information to the display apparatus, and the display apparatus acquires information on the boost block from the workstation and controls the backlight. However, the workstation may output information on the region of interest to the display apparatus, and the display apparatus may acquire information on the region of interest from the workstation, determine the position of the boost block based on the information on the region of interest, and control the backlight.

In Example 3, the workstation determines the region of interest in an image on one of the display apparatuses, corresponding to a region of interest specified by the other display apparatus, determines the position of the boost block in each display apparatus, and outputs this information to each display apparatus. However, this function of the workstation may be performed by a master display apparatus, which is one of a plurality of display apparatuses. In this case, the main display apparatus (master display apparatus) may acquire information on the blocks of the backlight from another display apparatus (slave display apparatus), and output the information on the boost block to the slave display apparatus. The slave display apparatus acquires information on the region of interest, which the user specified in the image displayed on another display apparatus (master) (first specified region), a second specified region which is a region on the master display apparatus corresponding to the first specified region, or information on blocks of the backlight of the master display apparatus corresponding to the second specified region. The slave display apparatus may determine the second specified region from the information on the first specified region and the information of the blocks of the two display apparatuses, and determine a block corresponding to the second specified region. Or the slave display apparatus may determine a block corresponding to the second specified region from the information on the second specified region. Or the slave display apparatus may acquire the information on the block corresponding to the second specified region, and allow this block, as the boost block, to emit light at a brightness higher than the normal block.

In the above examples, the output apparatus determines the boost block based on the information on the region of interest which the user input to the output apparatus, and sends the information on the boost block to the display apparatus. Then the display apparatus specifically determines at what brightness the boost block is allowed to emit light. However, the information to specify the brightness of the boost block may also be determined by the output apparatus, and the output apparatus may send the information to specify (instruct) a block to be boosted and the brightness thereof, to the display apparatus.

In order to input an instruction to specify the region of interest, various methods are possible other than the methods described in each of the above examples. These input methods can be applied to the present invention. For example, a user’ gesture is imaged by an imaging apparatus, the captured moving image is analyzed so that instruction content corresponding to the gesture is interpreted, and the region of interest is specified in accordance with the instruction content.

The instruction may be input using an apparatus for inputting an instruction (input apparatus), which is separate from the display apparatus and the output apparatus. For example, the diagnostic image is displayed on a tablet terminal, and the user operation to specify a region is received on the tablet terminal, and an instruction corresponding to this user operation is input to the output apparatus or the display apparatus. In this case, the input unit, which inputs the user operation, included in the display apparatus or the output apparatus, becomes a receiving unit that receives the user operation information or the corresponding command content from the tablet terminal by cable or wireless.

In Example 3, a configuration where the first display apparatus and the second display apparatus are not connected to the same image output apparatus is also possible. For example, the following situation can be assumed: the first display apparatus and the image output apparatus are connected with an image cable, and are physically disposed in a same location, and the second display apparatus is installed in a remote location. By this configuration, remote medical diagnosis or the like becomes possible. In this case, the first display apparatus and the second apparatus, or the image output apparatus and the second display apparatus may be connected via Internet or LAN, for example, so that information can be transmitted and received. For example, when user operation to specify the region of interest is performed in the first display apparatus or in the output apparatus, a command corresponding to this user operation (e.g. region information, boost block information, post-boosting brightness value information) is sent to the second display apparatus via a network. Then the second display apparatus receives the information to specify the region of interest, the boost block information and the post-boosting brightness value information via the network, and controls the backlight based on this information. Thereby in a plurality of display apparatuses installed at a remote location, the same area can be displayed at high brightness, and a system, to demonstrate a major effect of assisted communication between users, can be constructed in such a situation as remote diagnosis.

The example of the control of increasing the brightness of the block of the backlight corresponding to the region specified by the user operation was described in each of the above examples, but the present invention is also applicable to a spontaneous light emitting display apparatus. For example in an organic EL (Electro-Luminescence) display, control to increase brightness of a specified region can be performed. Further, in Example 3, the present invention is also applicable to a system in which a display having a backlight and a spontaneous light emitting display coexist as the first display apparatus and the second display apparatus.

In Example 3, the image displayed on the first display apparatus and the image displayed on the second display apparatus are images generated by capturing the same object, and the image in the first specified region and the image in the second specified region are images of this object captured under the same image capturing conditions. Here, in Example 3, the objects at a same position are imaged under the image capturing conditions, but image capturing conditions are not limited to a position.

According to the present invention, in a display apparatus for displaying medical images, an observation target image can be displayed at high gradation resolution, while suppressing the interference of black floaters and halos, and reducing power consumption.

The other characteristics of the present invention will be clarified in the following description on examples with reference to the accompanying drawings.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

1. A display apparatus, comprising:
a light emitting unit having a plurality of blocks of which brightness can be controlled independently;
a display unit configured to display an image by modulating light from the light emitting unit;
an input unit configured to input information on a specified region, specified by a user, in the image; and
a control unit configured to control brightness of the plurality of blocks, wherein
in a case where the information on the specified region is input, the control unit controls brightness of a block corresponding to a sub-region that includes the specified region, among a plurality of sub-regions of the image corresponding to the plurality of blocks, to a brightness higher than that in a case where the information on the specified region is not input.

2. The display apparatus according to claim 1, wherein
in a case where the information on the specified region is input, the control unit controls the brightness of the block corresponding to the sub-region that includes the specified region, to a brightness higher than brightness of a block corresponding to a sub-region that does not include the specified region.

3. The display apparatus according to claim 1, wherein
in a case where the information on the specified region is not input, the control unit controls brightness of each block within a first brightness range, according to a characteristic value of each sub-region, and
in a case where the information on the specified region is input, the control unit controls brightness of the block corresponding to the sub-region that includes the specified region, within a second brightness range which is wider than the first brightness range at least on the higher brightness side, according to the characteristic value of the sub-region that includes the specified region.

4. The display apparatus according to claim 1, further comprising a correction unit configured to correct an image of a sub-region corresponding to each block in accordance with the brightness of the block.

5. The display apparatus according to claim 4, wherein
the correction unit corrects the image using a DICOM curve.

6. The display apparatus according to claim 3, further comprising a correction unit configured to correct, in a case where the information on the specific region is input, a sub-image in a sub-region that does not include the specified region in accordance with the brightness of the corresponding block using a DICOM curve corresponding to the first brightness range, and correct a sub-image in a sub-region that includes the specified region in accordance with the brightness of the corresponding block using a DICOM curve corresponding to the second brightness range.

7. The display apparatus according to claim 1, wherein
the image is an image including an enlarged image generated by enlarging an image in a region specified by the user, and
the input unit inputs information on an enlarged region in which the enlarged image is displayed, as the information on the specified region.

8. The display apparatus according to claim 1, wherein
the input unit inputs information on a second specified region corresponding to a first specified region which is a region specified by the user in an image displayed on another display apparatus, and
the control unit controls the brightness of a block corresponding to a sub-region including the second specified region, so that the brightness becomes higher than a brightness in accordance with a characteristic value of the sub-region including the second specified region.

9. The display apparatus according to claim 1, wherein
the input unit inputs information on a first specified region, which is a region specified by the user in an image displayed on another display apparatus, and information on a plurality of blocks of a light emitting unit of the other display apparatus, and
the control unit determines a second specified region corresponding to the first specified region based on the information on the first specified region and the information on the plurality of blocks of the light emitting unit of the other display apparatus, and controls the brightness of a block corresponding to a sub-region including the second specified region, to a brightness higher than a brightness in accordance with a characteristic value of the sub-region including the second specified region.

10. The display apparatus according to claim 1, wherein
the specified region is constituted by one or a plurality of sub-regions, and
the block corresponding to the specified region is a block or blocks corresponding to the one or plurality of sub-regions.

11. The display apparatus according to claim 1, wherein
the block corresponding to a sub-region that includes the specified region is a block or blocks corresponding to one or a plurality of sub-regions including at least a part of the specified region.

12. The display apparatus according to claim 1, wherein
the display unit is a liquid crystal panel, and
the light emitting unit is a backlight.

13. The display apparatus according to claim 1, further comprising an operation unit configured for a user to specify a region in the image, wherein
the operation unit determines the specified region in accordance with user operation.

14. An output apparatus, comprising:
a connection unit for connecting to a display apparatus that includes a light emitting unit having a plurality of blocks of which brightness can be controlled independently, and a display unit configured to display an image by modulating light from the light emitting unit;
an acquisition unit configured to acquire information on the plurality of blocks in a case where the output apparatus is connected with the display apparatus;
an input unit configured to input information on a specified region, specified by a user, in the image; and
an output unit configured to output information for controlling brightness of at least one of the plurality of blocks, based on the information on the specified region and the information on the plurality of blocks, wherein
in a case where the information on the specified region is input, the output unit outputs, to the display apparatus, information for controlling brightness of a block corresponding to a sub-region that includes the specified region, among a plurality of sub-regions of the image corresponding to the plurality of blocks, to a brightness higher than that in a case where the information on the specified region is not input, based on the information on the plurality of blocks.

15. A display system, comprising:
a display apparatus that includes a light emitting unit having a plurality of blocks of which brightness can be controlled independently, and a display unit configured to display an image by modulating light from the light emitting unit; and
an output apparatus configured to output an image to the display apparatus, wherein
the output apparatus includes:
an acquisition unit configured to acquire information on the light emitting unit from the display apparatus;
an operation unit configured to specify a specified region in the image by user operation; and
an output unit configured to output information on the specified region and the image to the display apparatus,
the display apparatus includes:
an input unit configured to input the information on the specified region and the image from the output apparatus; and
a control unit configured to control the brightness of the plurality of blocks, and
in a case where the information on the specified region is input, the control unit controls brightness of a block corresponding to a sub-region that includes the specified region, among a plurality of sub-regions of the image corresponding to the plurality of blocks, to a brightness higher than that in a case where the information on the specified region is not input.

16. A control method for a display apparatus that includes a light emitting unit having a plurality of blocks of which brightness can be controlled independently, and a display unit configured to display an image by modulating light from the light emitting unit, the control method comprising:
inputting information on a specified region, specified by a user, in the image; and
controlling brightness of the plurality of blocks, wherein
in the controlling step, in a case where the information on the specified region is input in the inputting step, brightness of a block corresponding to a sub-region that includes the specified region, among a plurality of sub-regions of the image corresponding to the plurality of blocks, is set to a brightness higher than that in a case where the information on the specified region is not input.

17. The display apparatus according to claim 1, wherein
the control unit controls, in accordance with a characteristic value of each of the plurality of sub-regions, brightness of each of the plurality of light-emitting blocks, and
in a case where the information on the specified region is input, the control unit controls the brightness of the block corresponding to the sub-region that includes the specified region to a brightness higher than a brightness in accordance with the characteristic value of the sub-region.

18. The display apparatus according to claim 17, wherein
the control unit determines whether each of the plurality of sub-regions is a first region or a second region, in which an image brighter than the first region is displayed, in accordance with a characteristic value of each sub-region, and controls brightness of a block corresponding to the first region at first brightness, and controls brightness of a block corresponding to the second region at second brightness which is higher than the first brightness, and
in a case where the information on the specified region is input, the control unit controls the brightness of the block corresponding to the sub-region that includes the specified region to a brightness higher than the second brightness.

19. The display apparatus according to claim 7, wherein
the input unit inputs information on a block corresponding to a sub-region that includes the enlarged region, and
the control unit control brightness of the block corresponding to the sub-region that includes the enlarged region to a brightness higher than brightness of a block not corresponding to the sub-region that includes the enlarged region.

20. The display apparatus according to claim 8, wherein
the control unit controls brightness of a block corresponding to the sub-region that includes the second specified region to be higher than brightness of a block corresponding to a sub-region that does not include the second specified region.

21. A non-transitory computer-readable storage medium that holds a program to cause a computer to execute each step of a control method for a display apparatus that includes: a light emitting unit having a plurality of blocks of which brightness can be controlled independently; and a display unit configured to display an image by modulating light from the light emitting unit,
the control method comprising:
inputting information on a specified region, specified by a user, in the image; and
controlling brightness of the plurality of blocks, wherein
in the controlling step, in a case where the information on the specified region is input in the inputting step, brightness of a block corresponding to a sub-region that includes the specified region, among a plurality of sub-regions of the image corresponding to the plurality of blocks, is set to a brightness higher than that in a case where the information on the specified region is not input.
